(19) United States
(12) Patent Application Publication
(10) Pub. No.: US 2016/0100299 A1
(43) Pub. Date: Apr. 7, 2016

(54) Communication Method And System To Process And Control The Legality Of Products

(71) Applicant: Piotr Nawrocki, Inowroclaw (PL)

(72) Inventor: Piotr Nawrocki, Inowroclaw (PL)

(21) Appl. No.: 14/571,212

(22) Filed: Dec. 15, 2014

(30) Foreign Application Priority Data
Oct. 4, 2014 (EP) 14460060.8
Oct. 4, 2014 (EP) 14460061.6

(51) Int. Cl. H04W 4/18; G06Q 20/32; G06Q 20/40; H04L 29/08; H04W 4/00

(52) U.S. Cl. CPC H04W 4/185; H04L 67/2804; H04W 4/003; H04W 4/008; G06Q 20/4016; G06Q 20/3278

(57) ABSTRACT

A method and system of communication with an information exchange architecture within a DTA registry, which registry is designed to handle and control the legality of any commercial products. The system uses software and applications for smartphones and allows the identification of a product and information about its origin and legality.

### RELATED APPLICATIONS

This application claims priority to European Patent Application No. EP14460060.8, filed Oct. 4, 2014, entitled Communication Method And System With Information Exchange Architecture Designed To Handle And Control The Legality Of Products, and to European Patent Application No. EP14460061.6, filed Oct. 4, 2014, entitled Communication Method And System With DTA Register Architecture, both of which are hereby incorporated herein by reference in their entireties.

### CROSS-REFERENCE TO RELATED APPLICATIONS

The present application is related to U.S. patent application Ser. No. ______ [Attorney Docket No. 16019-308US] entitled Communication Method and System with DTA Register Architecture filed simultaneously with the present application, the entire contents of which are hereby incorporated by reference.

### FIELD OF THE INVENTION

The present invention relates to a method and system of communication with an information exchange architecture within a DTA registry, which registry is designed to handle and control the legality of any commercial products. The system uses software and applications for smartphones and allows the identification of a product and information about its origin and legality.

### BACKGROUND OF THE INVENTION

The problems of control and verification of copyright and the associated capital expenditures required thereby is faced by publishers, authors and creators of all kinds of copyrighted objects and exclusive rights to products of various industries.

For example, the publishing market is affected by a great problem of illegal book reprints done by publishing houses without the authors' permission. Another illegal method is scanning and copying publications. A similar situation occurs in the markets of cosmetics, pharmaceuticals, packaging, tobacco and other products subject to excise duty, as well as on a micro scale in situations where intellectual material products are illegally copied by competitors and marketed without regard to copyright. In 2011, European Union customs authorities seized more than 115 million products for which there was a suspicion of a violation of intellectual property rights. That was over 11 percent more than in 2010 (over 103 million). The value of seized goods reached almost 1.3 billion euros, compared to 1.1 billion euros in 2010.

Currently, the only widely used method of controlling the legality of a a product is protecting products with holograms. Unfortunately, this method is not effective due to the counterfeiting of holograms.

### OBJECTS AND SUMMARY OF THE INVENTION

The aim of the invention is to reduce illegal copying and control the legality of goods brought into the economy through a method and system using known transfer technologies and exchange of datato enable effective control and verification of data, location, control and monitoring of objects covered by copyright.

The system according to the invention uses the web, Near Field Comunication (NFC), and a product location mechanism and geotagging, as well as control mechanisms of selected levels of data access and implements them into storage systems. And by using a smartphone as a basic working tool of the system it is a universal, easy to use and reliable method and control system suitable for any type of product. The system can be implemented in any production process without the need for complex technological changes. The database system is designed to receive 1 billion marks (tags) per year with long-term maintenance and may be flexibly increased. Upon implementation, the system will form an integral part of the integrity and business ethics systems of commerce and a gradually developed sales and information platform.

The system of the present invention includes a method of operation and communication, as well as the infrastructure of the system. It provides a commercial solution allowing monitoring, controlling and structuring intellectual property of creators and authors, the legality of which a product and exchange of economic information is based on.

A primary aspect the communication method and system is NFC tags containing information about the product which cooperates through mobile applications with smartphones and databases. Markers are placed on a controlled product. Authentication of a product is done by identifiers permanently sewn in at the tags production stage. The tags contain information in accordance with the needs of a producer and tag technical capabilities (e.g., memory capacity). On markers issued together with information about the owner, the metadata provided by the manufacturer and subsequently the product life cycle, they are saved in a central database system—the copyright/ownership registry.

Access to information contained in the registry is done by a set of web applications that serve as a portal for the registry employees, authors, publishers, B2B automatic document exchange systems with external systems, external registries, portals, publishers, producers' systems, and interface for mobile phones or dedicated devices.

System mobile applications control the genuineness of a product and manage the work of auditors. The auditor, during an inspection, receives online information corresponding to the genuineness of a product and additional information necessary to properly acknowledge genuineness. At the same time, such data will be registered as a marker ID along with information about the time and location (GPS) of the inspection. If a given point of sale/inspection has a relevant marker, then a point of sale will be identified automatically. The application also collects information offline and confirms it together with its transfer to the database when connected to the Internet.

Selected aspects of the system have access to certain NFC system functions, just as an author using NFC technology uses a simple mechanism to verify the credibility of a product, s/he can monitor the impression and identify the legality of copies, and geotagging each controlled product facilitates the monitoring of an impression.

A Client with NFC technology, has the ability to confirm the legality certificate, has simple access to other author's products, can easily find a product on a shelf via web and in the case of an option of online sale, and has the opportunity make a purchase using a smartphone.

Verifying institutions and system control bodies using NFC technology receive proof of a product authentication place, use a simplified system of monitoring of registered products and are able to control agents and translocation of a product from an author to a customer.

In the system according to the invention, a number of solutions in the field of communications and communications is used, including: NFC (Near Field Communication) for encrypted product identification; Bluetooth—for encrypted exchange of information; GPS (Global Positioning System) to automatically search for the location of the controlled product; Wi-Fi—used as a communication option for data exchange system; S-Beam—to encrypted identification of the product; a USB to encrypted exchange of information. In addition, a mobile phone location using GPS, available in any model of a smartphone, for possible deletion of data in case of loss or theft of a phone, login and access password and use the module or fingerprints scanning application. Identification of biometric characteristics: holder's photo, fingerprint, scan of the eyeball, etc.

For secure data transmission and authentication of applications and information, the system uses encryption algorithms in the form of secure coding. The application is a module of registry architecture. At the time of downloading, a purchased application is programmed with an encryption code that, during the inspection of the product, is used as an authenticity identifier of the read data. The system uses mechanisms with a high degree of control encryption during the whole process of data exchange between the application and the system, and during the transmission and storage of classified information. The method and the mode of mechanisms connection provide the uniqueness of the system and the control application.

The system has built-in GPS, which provides system's location-based services, tracks product inspection location, marks it and enters the location in the system for data processing, allowing the preparation of the map of the distribution of the products and for other statistical purposes.

### BRIEF DESCRIPTION OF THE DRAWINGS

FIG. 1 illustrates a diagram of basic control and communication of system components in accordance with the present invention;

FIG. 2 illustrates a diagram of the communication method and system for product checks in accordance with the present invention;

FIG. 3 illustrates a diagram of system operation in accordance with the present invention;

FIG. 4 illustrates elements of a system in accordance with the present invention;

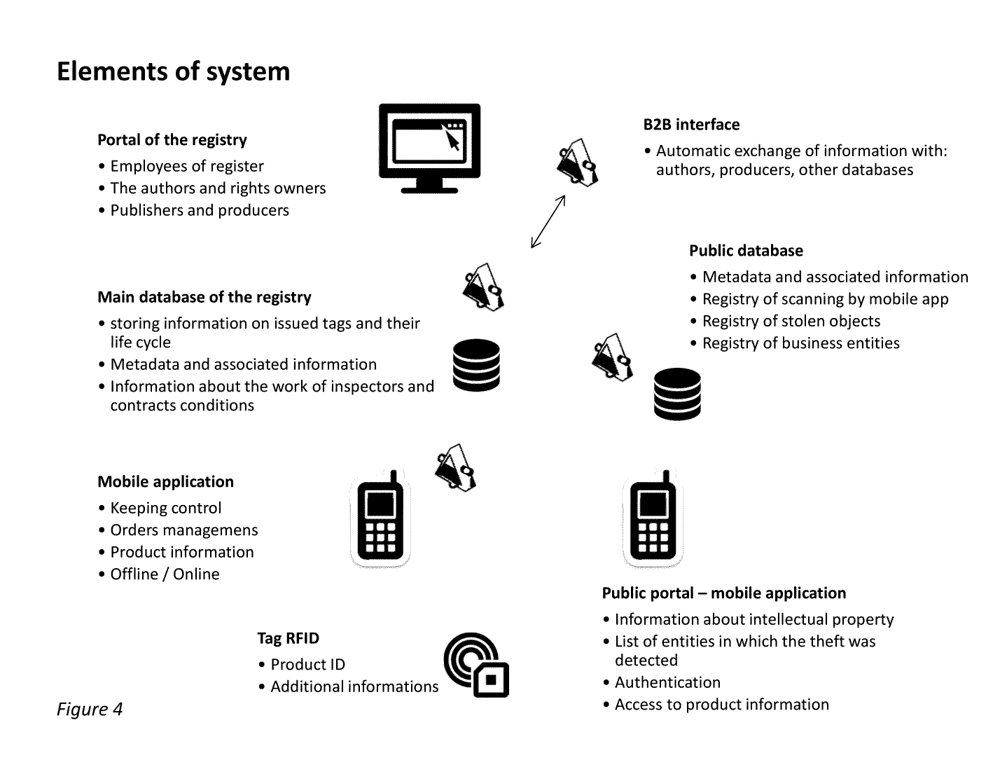

FIG. 5 illustrates features of features of portal/interface of B2B register in accordance with the present invention;

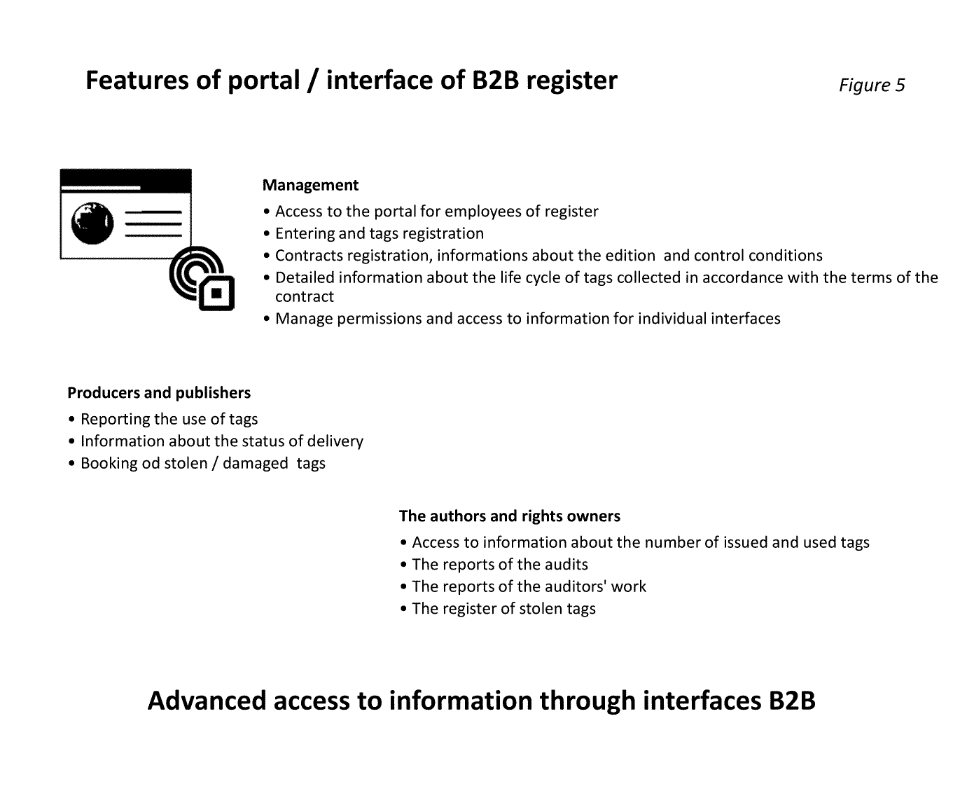

FIG. 6 illustrates mobile applications in accordance with the present invention;

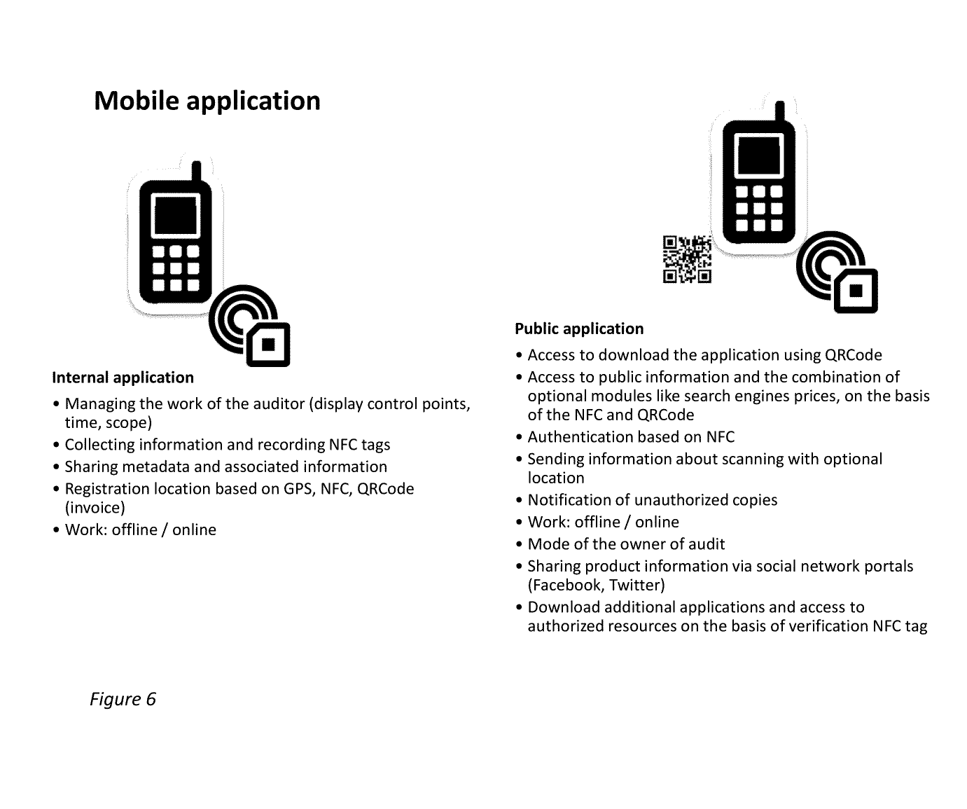

FIG. 7 illustrates registry functions in accordance with the present invention.

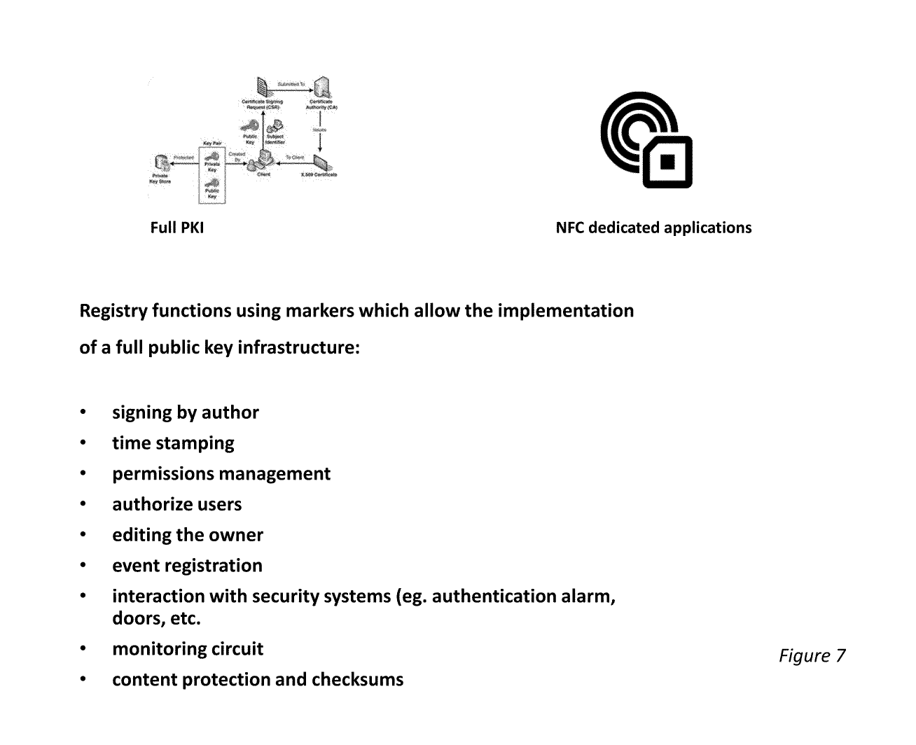

### DESCRIPTION OF EMBODIMENTS

The system uses an application interface designed for use by inspection bodies for the exchange of information between the application databases available to government inspection bodies.

Ultimately, the system will be equipped with a manual device programmed to receive information on the location of a product at the point of sale, industry licensing monitoring or licenses for products subject to excise duty.

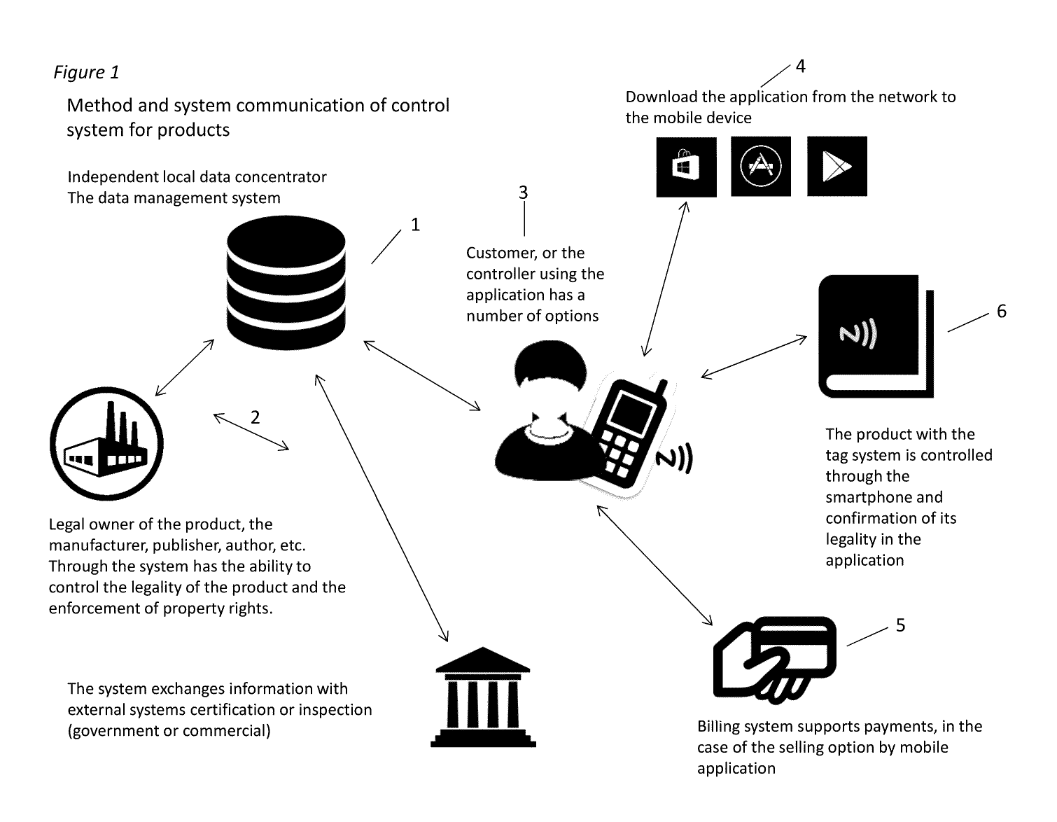

The system and method of operation of the system components is shown in the embodiment in the accompanying illustrative material, in which FIG. 1 shows a diagram of the basic control and communication of system components, consisting of an independent data concentrator 1—data management system exchanging information with external certification 2 or control (governmental or commercial) systems, a controller 3 using a smartphone system application 4, billing system 5 that supports the payment, and the marker product 6, controlled by approximating the smartphone and confirming or denying its legitimacy in the application,

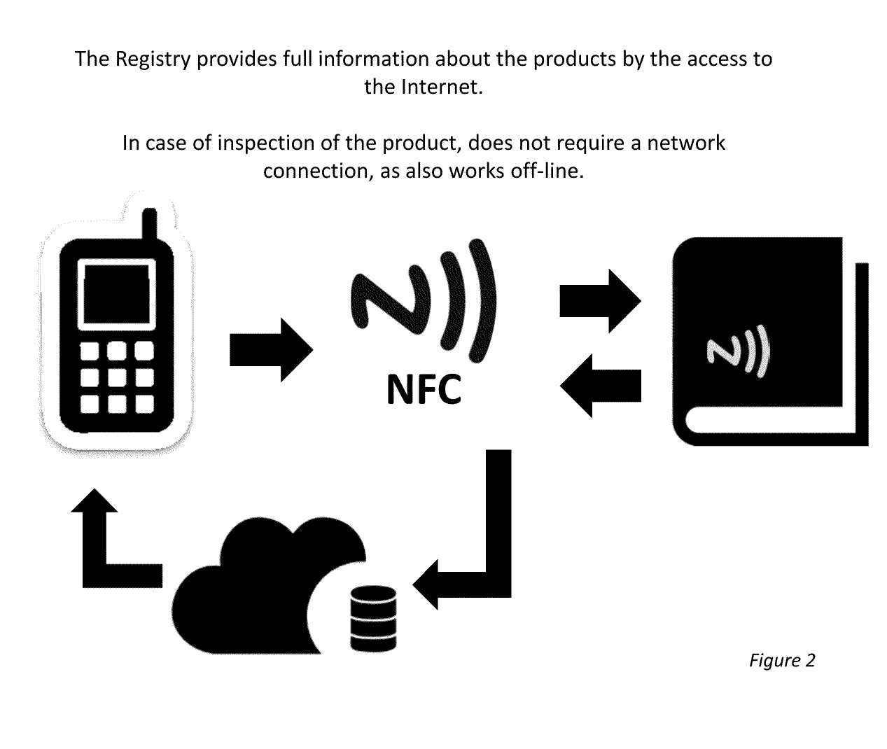

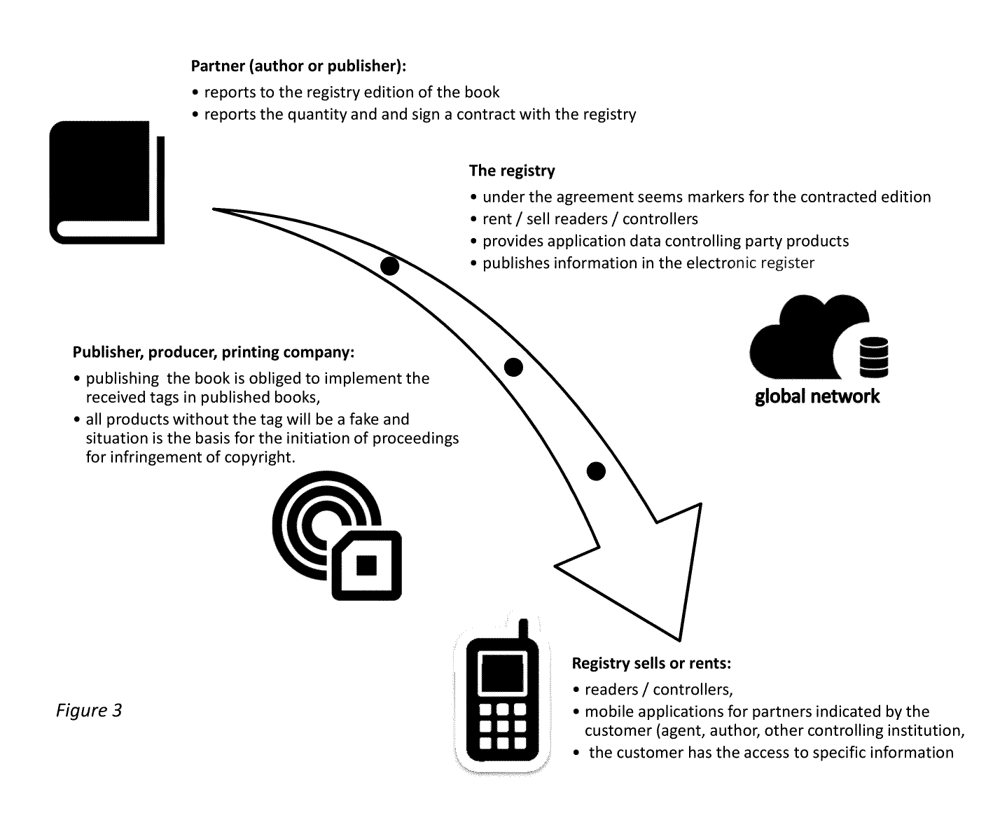

FIG. 2 shows a diagram of the communication method and system for product checks, FIG. 3—a diagram of system operation.

Information from the tag obtained using a smartphone loaded with with the application and using NFC technology is transferred to the system-database-register. Successively, the register using the access to the Internet gives full information about the product to th smartphone, and the system, through information exchange mechanisms via smartphone, checks whether the product has a tag that protects the product from copying, thereby locating the product or its counterfeit.

The mobile application has a number of functionality options: downloading additional applications and access to authorized resources on the basis of verification of an NFC tag; access to applications and portals; downloading resources, such as books on the basis of authentication of an authorized book; manage the additional work and information collected during the tag authentication.

The application reports the violation of intellectual property rights and starts a control procedure. In the case of product inspection it is not required to connect to the network because it also works off-line after data transfer.

Starting the control involves to the product registration process, which requires intermediate parties, such as publisher, subcontractor, distributor of the product, to incorporate system tags into a given batch of a product.

The system uses tags to enable implementation of full public key infrastructure for high-value and smaller circulation products. Smart tags with dedicated applications allow the construction of additional functionalities, such as: in works of art: information about the work, hire life cycle; in securities and classified documents: confirmation of integrity, checksums, content; in high-end equipment: access to dedicated applications, controls etc.

Scanning the product and authenticity ID takes place during the inspection of the product. The encrypted data is transmitted through proximity communication, Bluetooth, RFID or adjacency device—built-in a smartphone depending on the method chosen by the user.

The central database will be maintained by a target commercial entity and may access specific functions of a government agency or contractor hired by a government agency. It is up to a government agency to choose the method of registration and geolocation of a controlled product: by ordering from an intentional entity or registration with the URL of government agencies.

The smartphone interface will be maintained and regularly updated by the target operator. And the system includes the option to integrate with all available operating systems. There are several methods of valuation for using the system, including free downloadable versions for end users.

The individual functions dedicated to the control methods presented in the example have been prepared in accordance with the method of operation of the industry. In the case of other areas in which the system will be implemented, it can vary considerably due to the law relevant to the industry. This does not affect the method and manner of operation of the system. Construction of the system and the application allows configuration changes in accordance with the legal requirements of relevant certifying authorities.

The system according to the invention is shown in more detail in an operational embodiment

The basic element of the system are NFC tags placed by publishers and manufacturers at the stage of printing or packaging production. Tags shall be issued to the manufacturer in accordance with the ordered impression. Basic authentication of products is done by identifiers permanently sewn in at the production stage of the tags. The tags also contain additional information in accordance with the needs of a producer and subject to technical capabilities (in particular memory capacity). All information on markers issued together with information about the owner, the metadata provided by the manufacturer and subsequently the product life cycle are placed in a central database system—the copyright/ownership registry. Access to information contained in the system is done by a set of web applications as a portal for the registry employees, authors, publishers, B2B automatic document exchange systems with external systems (external registries, portals, publishers, producers' systems) and interface for mobile phones or dedicated devices. Mobile applications will be designed for monitoring the genuineness of products and will optionally enable managing the auditors' work. During an inspection an auditor will receive online information confirming the genuineness of a product, and any additional information necessary to properly acknowledge genuineness. At the same time, such data will be registered as a marker ID along with , information about the time and location (GPS) of the inspection. If a given point of sale/inspection has a relevant marker it will be possible to identify a point of sale automatically. The application will also collect information offline and confirm it together with its transfer to the database when connected to the Internet.

1. Communication system with information exchange architecture within a DTA registry, designed to handle and control the legality of any commercial products, using software and applications for smartphones, comprising an independent data concentrator; data management system; with external certification and/or control systems; a controller with a system application on a smartphone; a billing system that supports payment; and tags to verify the legality via a smartphone.

2. Communication system architecture information exchange within a registry DTA, designed to handle and control the legality of any commercial products, using software and applications for smartphones, comprising NFC technology; a mechanism of product location and geotagging; a control mechanism for selected data access levels and implementing such data into storage systems by using a smartphone as a primary tool of the system.

3. The method of communication with an information exchange architecture within an DTA registry, designed to handle and control the legality of any commercial products using software and applications for smartphones, comprising using NFC tags affixed to a product to obtain product information collaborating, via mobile applications with a smartphone, with databases, and accessing information contained in the system through a set of web applications.

4. The communication method according to claim 3, wherein the information from the tag using a smartphone application and NFC technology is transferred to a system-database-register, and sequentially, the register, using the Internet, provides information about the product, and the system checks via smartphone whether the product has a tag, thereby locating the product or its counterfeit.
